(19) United States
(12) Patent Application Publication
(10) Pub. No.: US 2003/0163344 A1
(43) Pub. Date: Aug. 28, 2003

(54) Method and system of providing a customer-selected remote control feature package in a vehicle

(76) Inventor: Kenneth E. Flick, Douglasville, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/085,403

(22) Filed: Feb. 28, 2002

(51) Int. Cl. G06F 17/60

(52) U.S. Cl. 705/1

(57) ABSTRACT

A method of providing a customer-selected remote control feature package in a vehicle includes installing in the vehicle a universal remote control device that can provide a plurality of distinct remote control feature packages, each of which can be separately and selectively enabled. The method also includes negotiating sale or lease of the vehicle to a customer, including offering one of the plurality of remote control feature packages and accepting the customer's selection. The method further includes wirelessly enabling the package selected. The system includes a universal remote control device and a remote control features package processing station that processes customer selection orders and wirelessly enables remote control feature packages in response to the orders.

### FIELD OF THE INVENTION

This application is related to the field of remote control systems and, more particularly, to remote control systems for a vehicle.

### BACKGROUND OF THE INVENTION

Modern automobiles typically include a wide assortment of remote control features. Various types of remote control features can be used to make the driver and passengers in the vehicle more secure, safeguard the vehicle when it is unoccupied, and generally enhance the convenience of the driver and passengers. Typical features may relate to keyless entry, remote vehicle security arming and disarming, and remote engine starting, for example. Other features may relate to vehicle tracking, including tracking using a global positioning satellite (GPS) for both security and on-board navigation.

Some remote control features may be included as standard equipment on a particular make or model of a vehicle. More commonly, however, the features are provided by after-market devices, which are installed at the purchaser's request. Typically, it is the dealer or an independent contractor that will be called upon to install the requested security or convenience devices after the vehicle has been delivered from the factory to the dealer.

Not all prospective purchasers have identical tastes, and accordingly, not every purchaser will desire the same features in a vehicle. Therefore, to satisfy each customer's particular desire for a specific package of remote control features, a dealer maintains a large inventory of different types of different devices to be able to provide a specifically requested remote control feature package for each particular purchaser. Maintaining a large inventory of different remote control devices, however, is costly and cumbersome for the dealer.

It is similarly difficult for a dealer to specially install a remote control feature package on a customer-by-customer basis as each vehicle is sold. Thus, to date, dealers have had to attempt to balance the benefits of meeting each customer's particular demand against the costs of maintaining large inventories of different remote control devices and installing different packages of features on a customer-by-customer basis.

One strategy is for the dealer to market vehicles having a particular, pre-installed package of features that is intended to at least approximately correspond to the tastes of the average vehicle purchaser. Of course with pre-installed packages, because not every customer will want the same package of features, the dealer will often have to discount those features that a particular purchaser does not necessarily want. Conversely, the dealer may not be able to fully pass on the cost of inventory maintenance and installation of additional features, not included as part of the basic feature package, but requested by a particular customer.

The problem is likely to be just as acute in used car sales and/or vehicle leasing markets where, again, not all customers have the same desire for safety and convenience features.

### SUMMARY OF THE INVENTION

In view of the foregoing background, it is therefore an object of the present invention to provide a more efficient and cost effective method and system of providing customer-selected remote control feature packages in vehicles.

This and other objects, advantages and features in accordance with the present invention are provided by a method through which a customer can purchase a particular remote control feature package by choosing from among a variety of possible packages. More particularly, the method may include installing in a vehicle a universal remote control device, the device having a controller and wireless receiver cooperating therewith to permit wireless enabling of a customer-selected remote control feature package from among a plurality of possible remote control feature packages.

The method may also include negotiating a vehicle's sale or lease. Negotiating, in turn, may include offering a customer a plurality of different remote control feature packages, and accepting from the customer an order for the customer-selected remote control feature package. The method may further include wirelessly enabling the customer-selected remote control feature package for the universal remote control device.

Accordingly, through installation of the universal remote control device, a plurality of different remote control feature packages can be offered and a specific customer-selected package provided to a customer. A vehicle provider (e.g., a dealer) benefits by not having to maintain a large inventory of different remote control devices and by not having to install different types of devices on a customer-by-customer basis.

The vehicle may be delivered to a customer after the negotiation between a dealer and a customer, but before the customer-selected remote control package is wirelessly enabled. The universal remote control device itself may be installed in a vehicle before or after delivery of the vehicle to a dealer. The device may be installed either before or after the negotiation between the dealer and a customer.

The various steps of the method, moreover, may each be performed by the same or different entities. Thus, the method may further include sharing revenue when the method is performed by two or more entities. The revenue may be shared based on a negotiated price at which a customer-selected remote control feature package is provided to a customer.

Another aspect of the invention relates to a system for providing a customer-selected remote control feature package in a vehicle. The system may include a universal remote control device that can be installed in a vehicle to provide one of a plurality of remote control feature packages according to a customer selection. The system also includes a customer-selected remote control feature package processing station for processing customer selection orders and wirelessly enabling remote control feature packages in response to the orders.

Moreover, if different entities are involved in providing, installing, negotiating, or enabling the remote control feature package, the processing station also may share revenue among the different entities. Accordingly, the processing station preferably includes an accounting database for sharing revenue.

The universal remote control device itself preferably includes a controller and a wireless receiver. The wireless receiver cooperates with the controller to provide for the wireless enabling of the remote control feature package selected by a customer from among the plurality of packages possible from the universal remote control device. Preferably, the wireless receiver is a cellular radio receiver so that wireless enabling can be accomplished using a cellular radio transmitter.

The universal remote control device is preferably capable of performing at least one of the functions of security, remote keyless entry, and remote engine starting. The universal remote control device may also be capable of performing vehicle tracking, and, accordingly, the device further may include a GPS receiver for performing vehicle position tracking.

The controller of the universal remote control device preferably includes a processor and may include also a memory connected to the processor. In some embodiments, moreover, the controller interfaces to a data communication bus within the vehicle. Via the data communication bus, data can be exchanged between the processor and various additional devices. Thus, for example, the processor can connect through the interface via the vehicle data communication bus to the vehicle door locks, an alarm indicator, the engine starter, and various sensors.

### BRIEF DESCRIPTION OF THE DRAWINGS

FIG. 1 is a flow chart illustrating a method of providing a customer-selected remote control feature package in a vehicle in accordance with the present invention.

FIG. 2 is a schematic diagram of a system in accordance with the present invention.

FIG. 3 is a more detailed schematic diagram of portions of the system as shown in FIG. 2.

FIG. 4 is a more detailed schematic block diagram of a universal remote control device as shown in FIG. 2.

### DETAILED DESCRIPTION OF THE PREFERRED EMBODIMENTS

The present invention will now be described more fully hereinafter with reference to the accompanying drawings in which preferred embodiments of the invention are shown. This invention, however, may be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout.

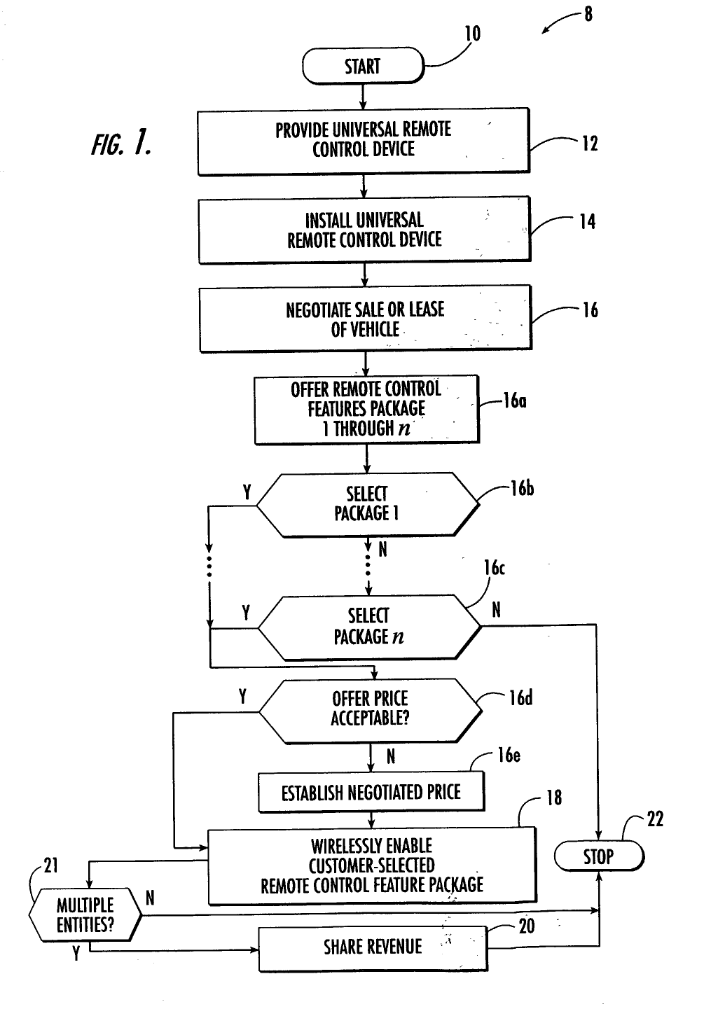

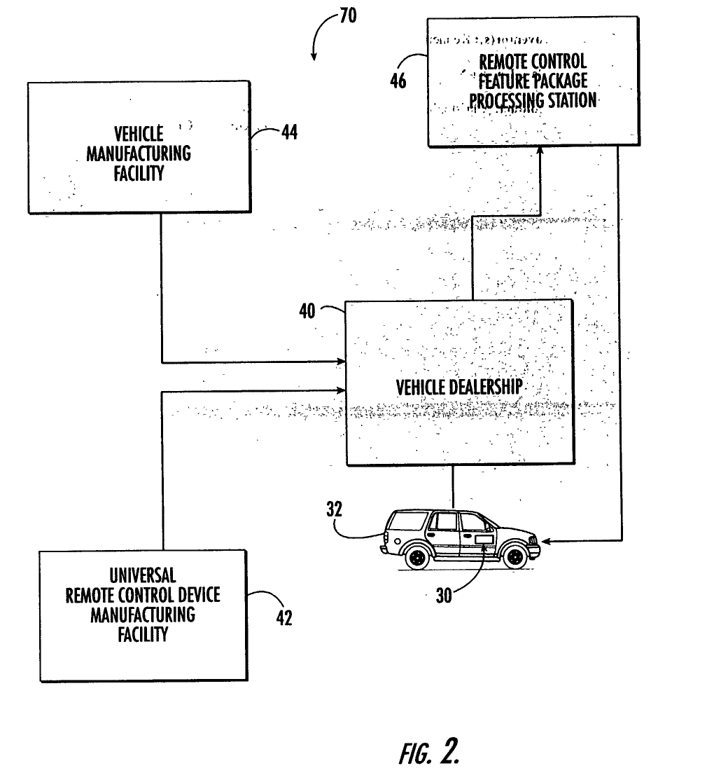

Referring initially to FIGS. 1 and 2, a method and system of providing a remote control feature package in a vehicle according to one aspect of the invention are first described. The method as shown in the flow chart 8 after the start (BLOCK 10) includes installing in the vehicle a universal remote control device 30 (BLOCK 14). The universal remote control device 30 includes a controller and a wireless receiver cooperating with the controller to permit wireless enabling of the customer-selected remote control feature package from among a plurality of possible remote control feature packages.

The method also illustratively includes negotiating with a customer for the sale or lease of a vehicle having a particular remote control feature package at BLOCK 16. In negotiating the sale or lease, a dealer preferably offers to a customer the plurality of different remote control feature packages that are possible with the universal remote control device 30 (BLOCK 16a). The customer responds by selecting a remote control feature package from among the plurality of packages (BLOCK 16b-c). During the negotiation, the plurality of remote control feature packages may be offered at pre-selected offer prices (e.g., list prices). If an offer price is unacceptable, negotiations continue (BLOCK 16d) until either agreement is reached or the customer rejects all offers. In the later event, the negotiations stop at BLOCK 22.

If, however, the customer and dealer can reach agreement on a price, the steps proceed as illustratively indicated. Accordingly, the dealer and customer will have arrived at a negotiated price for a customer-selected remote control feature package (BLOCK 16e), the negotiated price being different from the offer price of the package.

Once the customer selects a particular remote control feature package at an agreed price, the dealer accepts the customer's order for the customer-selected remote control feature package. The method thus further includes wirelessly enabling the remote control package selected by the customer from among the plurality of remote control feature packages offered during the negotiation (BLOCK 18). The method concludes at BLOCK 22 unless other entities are involved in the provision of the remote control feature package (BLOCK 21), in which case revenue may be shared at BLOCK 20 as explained below.

Thus, through installation of the universal remote control device 30, a plurality of different remote control feature packages can be offered and a customer-selected package provided to a customer. Each remote control feature package corresponds to one of the various permutations of features that can be separately and selectively enabled.

It follows that a provider such as a vehicle dealer benefits by not having to maintain a large inventory of different remote control devices. The dealer also benefits by not having to install different types of devices on an irregular schedule dictated by the upswings and downturns in customer purchase or leasing activity. The universal remote control device 30 can be installed at any time irrespective of sales and leasing activity, and a customer-selected package can be provided through wireless enabling.

The method permits delivery of the vehicle to a customer after the negotiation and before the remote control feature package selected by the customer is wirelessly enabled. Alternately, the negotiation can be concluded and the customer-selected remote control feature package enabled before the vehicle is delivered to the customer. In either scenario, however, additional installation activity may not be needed beyond installing the universal remote control device 30. The universal remote control device 30 can be installed prior to the negotiation between the dealer and customer, or, alternately, after the negotiation.

Another aspect of the invention relates to providing the customer-selected remote control feature package in a vehicle wherein providing a universal remote control device 30 (BLOCK 12), installing the device in the vehicle 32 (BLOCK 14), negotiating the sale or lease of the vehicle and feature package (BLOCK 16), and wirelessly enabling the selected remote control feature package (BLOCK 18) may be performed by at least two different entities.

For example, the universal remote control device 30 may be manufactured by a vehicle manufacturer at a vehicle manufacturing facility 44 where the device may be installed in a vehicle before delivery of the vehicle to a vehicle dealership 40. Alternatively, the device 30 may be manufactured by a different entity such as a device manufacturer at a device manufacturing facility 42, after which the device may be delivered to the vehicle manufacturer's facility 44 for installation in a vehicle. As illustratively shown in FIG. 2, however, the device 30 alternately may be manufactured by the device manufacturer and then delivered directly to a vehicle dealership 40. The dealer may install the device 30 in the vehicle 32, or, alternately, the dealer may contract with an independent entity to install the device in the vehicle after the vehicle has been delivered from a vehicle manufacturer's facility 44. In this later scenario, three distinct entities would be involved in providing a remote control feature package to a customer: the device provider who manufactures the device, the contractor who installs the device in a vehicle, and the dealer who negotiates the sale or lease of the vehicle and remote control feature package.

The dealer may also assume the task of wirelessly enabling the remote control feature package selected by a customer. Alternately, however, the manufacturer, installer, or still yet another entity could take on the task. In the later scenario, as many as four entities may be involved in providing the remote control feature package to a customer. Moreover, because the customer-selected remote control feature package is wirelessly enabled, the task of enabling can be performed at a location away from any of the vehicle manufacturing facility 44, the device manufacturing facility 42, and the vehicle dealership 40, as well as away from the vehicle 32. For example, as explained in more detail below, the wirelessly enabling of the package can be performed by a remote control feature package processing station 46.

Often times it will be the dealer that garners the premium in the event that the final negotiated price represents a high profit margin, and, accordingly, it will be the dealer that bears the risk that the negotiated price may have to be significantly discounted to conclude a deal. Alternately, though, when other entities are involved in providing the remote control feature package, it may be that one or more of them forgoes a fixed payment and instead earns a prorated share of the revenue generated from providing the remote control feature package to an ultimate purchaser. Accordingly, another aspect of the method pertains to sharing revenue (BLOCK 20).

In general, each of the plurality of possible remote control feature packages will be offered at a different offering price, typically in accordance with the number and desirability of the remote control features included in the particular package. Accordingly, revenue may be shared among two or more entities based on the negotiated price.

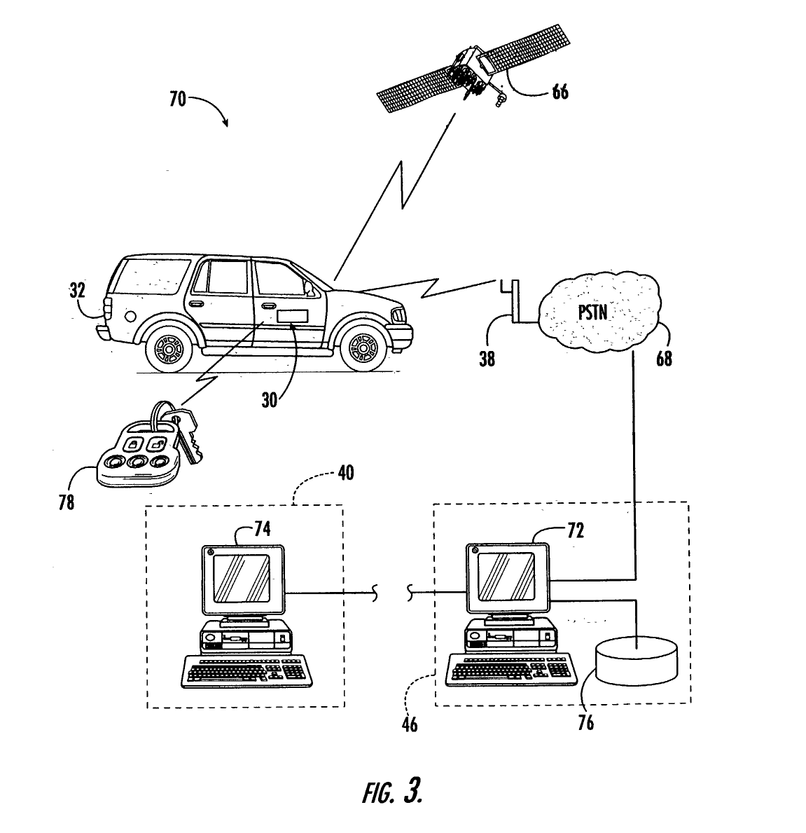

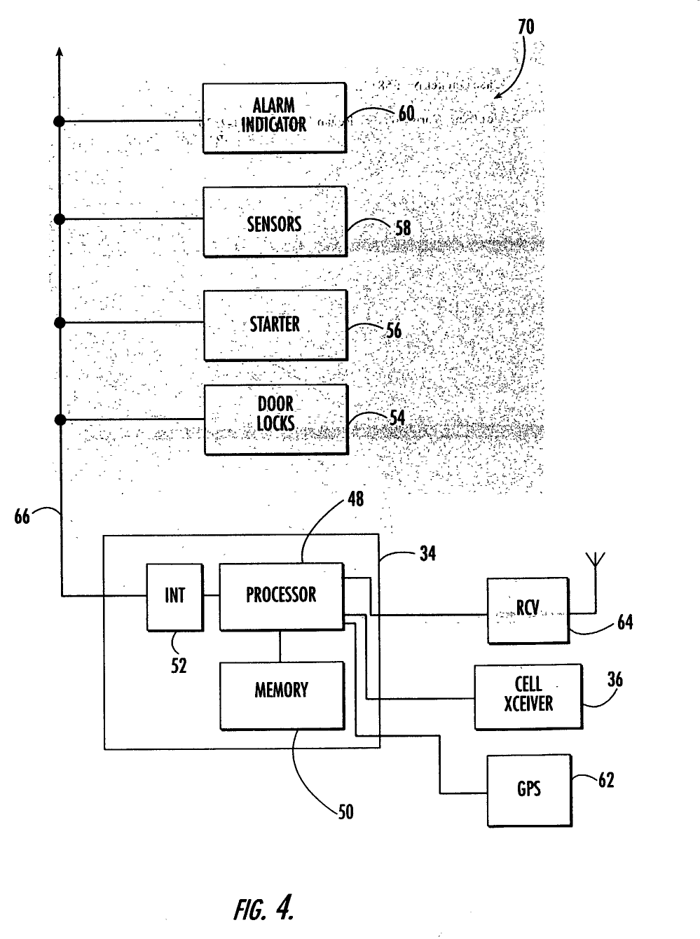

Referring now additionally to FIGS. 3 and 4, further details of the method and system are now described. The system 70 includes the universal remote control device 30 having a controller 34 and wireless receiver 36 operating in cooperation therewith to permit wireless enabling of the customer-selected remote control feature package. The illustrated system also includes a remote control feature package processing station 46 for receiving customer orders for remote control feature packages and for enabling remote control feature packages in response to the orders.

Turning first to the remote control feature package processing station 46, the processing station 46 illustratively includes a computer terminal 72 to receive orders from a remote terminal 74 at the vehicle dealership 43, for example, via the Internet. The station also may process orders received via telephone or fax. As will be readily appreciated by one skilled in the art, various other modes of receiving orders for processing are of course also possible.

Regardless of how an order is relayed, the remote control feature package processing station 46 processes the order, and, in response to the order, wirelessly enables the particular customer-selected remote control feature package. Because the universal remote control device 30 includes a wireless receiver 36 that cooperates with the processor 34 to permit wireless enabling of the remote control feature package, the processing station 46 can enable the customer-selected package via a wireless signal transmission.

For example, the wireless receiver 36 can be a cellular radio receiver, and the remote control feature package processing station 46, accordingly, can wirelessly enable a remote control feature package using a cellular radio transmitter 38. As shown in the illustrated embodiment, the enabling signal can be sent via a public switched telephone network (PSTN) 68 to the cellular radio transmitter 38, and from the transmitter 38 to the wireless receiver 36 of the universal remote control device 30.

As will also be appreciated by those skilled in the art, wireless enabling permits the remote control feature processing station 46 to be located remotely from the universal remote control device 30 and the vehicle 32 in which the device is installed. The universal remote control device 30 may be advantageously installed at the facility where the vehicle is manufactured, after which the vehicle may be delivered to a dealership. The dealer will negotiate a sale or lease of the vehicle 32 and associated remote control feature package as described above. After the negotiation, the negotiated order will be processed at the remote control feature package processing station 46, and the customer-selected remote control feature package will be wirelessly enabled from the station via the PSTN 68 and cellular radio transmitter 38.

The device may also be advantageously installed in a vehicle 32 after the vehicle is delivered to a dealer. The dealer will negotiate the sale or lease of the vehicle 32 along with an associated remote control package, and, again, the order will be processed and the package enabled from the remotely located remote control feature package processing station 46 using, for example, a signal sent via the PSTN 68 and cellular transmitter 38.

In the event that different entities are involved in any of the activities of providing, installing, negotiating and enabling, as described above, the remote control feature package processing station 46 preferably allocates revenues among the different entities. As shown in the illustrated embodiment, the remote control feature package processing station 46 includes a database 76. The database is preferably an accounting database for sharing revenue as described herein.

Turning now to the universal remove control device 30 itself, the device preferably includes, in addition to the controller 34 and wireless receiver 36, a hand-held remote radio transmitter 78 and in-vehicle radio receiver 64 to permit the customer to remotely operate the features of the remote control feature package once the package has been enabled. The features of the universal remote control device 30 as already noted can include various security and convenience features. The features may include at least remote keyless entry, remote security activation, and remote engine starting as will be readily understood by those skilled in the art.

The features may also include vehicle position tracking. The universal remote control device 30, therefore, may further include a GPS receiver 62 for performing vehicle position tracking based on global positioning information received from a satellite 66. Tracking also can be used for security and on-board navigation.

As shown in FIG. 4, the controller 34 of the universal remote control device 30 may include a processor 48 and may also include a memory 50 connected to the processor for storing processing instructions and data, as will be readily understood by one skilled in the art. The controller 34 also illustratively includes an interface 52 to connect the processor 48 to other devices within the vehicle. These connections can be dedicated hardwired connections or via a data communication bus 66 that extends within the vehicle 32, as will be readily understood by one skilled in the art. Through the data communication bus 66, data can be exchanged between the processor and additional bus-connected devices that perform the various remote control features of the universal remote control device 30. These additional bus-connected devices may include, for example, door locks 54, the engine starter 56, various sensors 58, and an alarm indicator 60.

Many modifications and other embodiments of the invention will come to the mind of one skilled in the art having the benefit of the teachings presented in the foregoing descriptions and associated drawings. Therefore, it is to be understood that the invention is not to be limited to the specific embodiments disclosed, and that other modifications and embodiments are intended to be included within the spirit and scope of the appended claims.

That which is claimed is:

1. A method of providing a customer-selected remote control feature package in a vehicle, the method comprising:
installing a universal remote control device in the vehicle, the universal remote control device comprising a controller and a wireless receiver cooperating therewith for permitting wireless enabling of the customer-selected remote control feature package from among a plurality of possible remote control feature packages;
negotiating sale or lease of the vehicle with the customer and comprising
offering the plurality of possible remote control feature packages to the customer, and
accepting an order for the customer-selected remote control feature package from the customer; and
wirelessly enabling the customer-selected remote control feature package for the universal remote control device.

2. A method according to claim 1 further comprising delivering the vehicle to the customer after negotiating and prior to wirelessly enabling.

3. A method according to claim 1 wherein installing is performed prior to negotiating.

4. A method according to claim 1 wherein installing is performed after negotiating.

5. A method according to claim 1 wherein the plurality of possible remote control feature packages have respective different offering prices; and wherein the customer-selected remote control feature package has a negotiated price associated therewith.

6. A method according to claim 5 wherein negotiating and wirelessly enabling are performed by respective different entities; and further comprising sharing revenue between the different entities and based on the negotiated price for the customer-selected remote control feature package.

7. A method according to claim 5 further comprising providing the universal remote control device; wherein the installing, negotiating, and wirelessly enabling are provided by respective different entities; and further comprising sharing revenue between the different entities and based on the negotiating price for the customer-selected remote control feature package.

8. A method according to claim 7 wherein the providing and wirelessly enabling are provided by a same entity.

9. A method according to claim 1 wherein negotiating is performed by a vehicle dealer; and wherein installing is performed after vehicle delivery to the vehicle dealer.

10. A method according to claim 1 wherein negotiating is performed by a vehicle dealer; and wherein installing is performed prior to vehicle delivery to the vehicle dealer.

11. A method according to claim 1 wherein installing comprises installing the universal remote control device to perform at least one of security, remote keyless entry and remote engine starting features associated with respective customer-selected remote control feature packages.

12. A method according to claim 11 wherein security comprises vehicle position tracking.

13. A method according to claim 12 wherein the universal remote control device comprises a GPS receiver for performing the vehicle position tracking.

14. A method according to claim 1 wherein the wireless receiver comprises a cellular radio receiver; and wherein the wirelessly enabling comprises using a cellular radio transmitter.

15. A method according to claim 1 wherein the vehicle comprises a data communication bus extending therethrough; and wherein installing comprises connecting the universal remote control device to the vehicle data communication bus.

16. A method of providing a customer-selected remote control feature package in a vehicle, the method comprising:
providing a universal remote control device comprising a controller and a wireless receiver cooperating therewith for permitting wireless enabling of the customer-selected remote control feature package from among a plurality of possible remote control feature packages;
installing the universal remote control device in the vehicle;
negotiating sale or lease of the vehicle with the customer and comprising
offering the plurality of possible remote control feature packages to the customer, the plurality of possible remote control feature packages having respective different offering prices, and
accepting an order for the customer-selected remote control feature package from the customer, the customer-selected remote control feature package having a negotiated price associated therewith;
wirelessly enabling the customer-selected remote control package for the universal remote control device; and
wherein providing, installing, negotiating and wirelessly enabling are performed by a plurality of different entities and further comprising sharing revenue among the different entities based on the negotiated customer-selected remote control feature package.

17. A method according to claim 16 further comprising delivering the vehicle to the customer after negotiating and prior to wirelessly enabling.

18. A method according to claim 16 wherein installing is performed prior to negotiating.

19. A method according to claim 16 wherein installing is performed after negotiating.

20. A method according to claim 16 wherein the providing and wirelessly enabling are provided by a same entity.

21. A method according to claim 16 wherein negotiating is performed by a vehicle dealer; and wherein installing is performed after vehicle delivery to the vehicle dealer.

22. A method according to claim 16 wherein negotiating is performed by a vehicle dealer; and wherein installing is performed prior to vehicle delivery to the vehicle dealer.

23. A method according to claim 16 wherein installing comprises installing the universal remote control device to perform at least one of security, remote keyless entry and remote engine starting features associated with respective customer-selected remote control feature packages.

24. A method according to claim 23 wherein security comprises vehicle position tracking.

25. A method according to claim 16 wherein the wireless receiver comprises a cellular radio receiver; and wherein the wirelessly enabling comprises using a cellular radio transmitter.

26. A method according to claim 16 wherein the vehicle comprises a data communication bus extending therethrough; and wherein installing comprises connecting the universal remote control device to the vehicle data communication bus.

27. A system for providing a customer-selected remote control feature package in a vehicle, the system comprising:
a universal remote control device for installation in the vehicle, said universal remote control device comprising a controller and a wireless receiver cooperating therewith for permitting wireless enabling of the customer-selected remote control feature package from among a plurality of possible remote control feature packages; and
a customer-selected remote control feature package processing station for
receiving an order for the customer-selected remote control feature package,
wirelessly enabling the customer-selected remote control package for the universal remote control device based upon the order, and
sharing revenue among different entities based upon the customer-selected remote control feature package.

28. A system according to claim 27 wherein said customer-selected remote control feature package processing station comprises an accounting database for sharing the revenue.

29. A system according to claim 27 wherein said universal remote control device performs at least one of security, remote keyless entry and remote engine starting features associated with respective customer-selected remote control feature packages.

30. A system according to claim 27 wherein said universal remote control device comprises a GPS receiver for performing vehicle position tracking.

31. A system according to claim 27 wherein said wireless receiver comprises a cellular radio receiver; and wherein said processing station wirelessly enables the customer-selected remote control feature package using a cellular radio transmitter.

32. A system according to claim 27 wherein the vehicle comprises a data communication bus extending therethrough; and wherein said universal remote control device interfaces to the vehicle data communication bus.
